(19) United States
(12) Patent Application Publication
(10) Pub. No.: US 2014/0326378 A1
(43) Pub. Date: Nov. 6, 2014

(54) TREAD COMPRISING TREAD PATTERN ELEMENTS COVERED WITH A THERMOPLASTIC MATERIAL

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventors: Vincent Abad, Clermont-Ferrand (FR); Frédéric Perrin, Clermont-Ferrand (FR); Marc Duvernier, Clermont-Ferrand (FR)

(73) Assignee: MICHELIN RECHERCHEET TECHNIQUE S.A., Granges-Pacoot (CH)

(21) Appl. No.: 14/364,618

(22) PCT Filed: Dec. 14, 2012
(86) PCT No.: PCT/EP2012/075606

§ 371 Date: Jun. 11, 2014

(30) Foreign Application Priority Data
Dec. 16, 2011 (FR) 1161803

(51) Int. Cl. B60C 11/00; B60C 1/00

(52) U.S. Cl. CPC B60C 11/005; B60C 11/0008; B60C 1/0016; B60C 2011/0025
USPC 152/209.5

(57) ABSTRACT

A tire tread having:
a plurality of tread pattern elements comprising lateral faces and a contact face which is intended to be in contact with the road surface when a tire provided with this tread is being driven on, the extent of the contact between the contact face and the ground forming at least one edge corner,
a plurality of cuts in the form of grooves and/or sipes, said cuts being delimited by opposing lateral faces,
each tread pattern element being formed with at least one first rubber compound (referred to as “base compound”),
   this tread having, viewed in section in a plane containing the thickness of the tread, at least one face delimiting at least one cut covered at least in part with a layer of a covering material, this tread being characterized in that the covering material is a thermoplastic material.

This application is a 371 national phase entry of PCT/EP2012/075606, filed 14 Dec. 2012, which claims priority to FR 1161803, filed 16 Dec. 2011, the contents of which are incorporated herein by reference for all purposes.

### BACKGROUND

1. Field

The disclosure relates to tires and more particularly to the tread of such tires.

2. Description of Related Art

In order to obtain satisfactory driving performance particularly on wet road surfaces, it is known practice to provide a tire tread with a tread pattern formed by tread pattern elements separated from one another by cuts (grooves with an average width greater than or equal to 2 mm and/or sipes with an average width of less than 2 mm), these cuts being obtained for example by moulding. The tread pattern elements thus formed comprise a contact face intended to come into contact with the road surface during driving and lateral faces also delimiting the cuts; the intersection of each lateral face with the contact face forms an edge corner facilitating contact between the tire and the road surface notably when the road surface is wet. More generally, an edge corner is defined as being the geometric boundary of the contact of a tread pattern element with the ground during driving.

With tread pattern elements the distinction is made between elements that do not go all the way around the tire (blocks) and elements that do go all around the tire (ribs). Moreover, the tread pattern elements may comprise one or more sipes to form additional edge corners, it being possible for each sipe either to open or not to open onto at least one lateral face of the tread pattern element. By definition, a sipe is the space delimited by two opposing main faces that are distant from one another by a width of less than 2 mm.

Document WO 2005/063509 discloses a tread for a tire tread comprising:
a plurality of tread pattern elements comprising lateral faces and a contact face which is intended to be in contact with the road surface when a tire provided with this tread is being driven on, the extent of the contact between the contact face and the ground forming at least one edge corner;
a plurality of cuts in the form of grooves and/or sipes, said cuts being delimited by opposing lateral faces;
each tread pattern element being formed with at least one first rubber compound referred to as “base compound”;

said tread having, viewed in section in a plane containing the thickness of said tread, comprises at least one groove covered with an elastomer composition that has an elastic modulus under compression E′ at 23° C. comprised between 30 and 50 MPa. This tread makes it possible to improve the wet performance of pneumatic tires equipped with it.

Tire designers are still, however, constantly preoccupied with improving the grip properties, particularly on snowy ground.

### SUMMARY

To this end, an embodiment of the invention proposes a rubber tread comprising:
a plurality of tread pattern elements (1) comprising lateral faces (13, 14, 15, 16) and a contact face (2) which is intended to be in contact with the road surface when a tire provided with this tread is being driven on, the extent of the contact between the contact face (2) and the ground forming at least one edge corner (23, 24, 25, 26),
a plurality of cuts (3, 4) in the form of grooves and/or sipes, said cuts (3, 4) being delimited by opposing lateral faces,
each tread pattern element (1) being formed with at least one first rubber compound (referred to as “base compound”),

this tread having, viewed in section in a plane containing the thickness of the tread, at least one face delimiting at least one cut covered at least in part with a layer of a covering material, this tread being characterized in that the covering material is a thermoplastic polymer composition with a Young's modulus higher than 100 MPa, and in that the thermoplastic polymer composition contains at least one thermoplastic polymer the glass transition temperature of which is positive, a poly(p.phenylene ether) (“PPE”), and a functionalized unsaturated thermoplastic styrene (“TPS”) elastomer the glass transition temperature of which is negative, the said TPS elastomer bearing functional groups selected from the epoxide, carboxy, anhydride or acid ester groups.

Another subject of an embodiment of the invention is a rubber tread comprising:
a plurality of tread pattern elements (1) comprising lateral faces (13, 14, 15, 16) and a contact face (2) which is intended to be in contact with the road surface when a tire provided with this tread is being driven on, the extent of the contact between the contact face (2) and the ground forming at least one edge corner (23, 24, 25, 26),
a plurality of cuts (3, 4) in the form of grooves and/or sipes, said cuts (3, 4) being delimited by opposing lateral faces,
each tread pattern element (1) being formed with at least one first rubber compound (referred to as “base compound”),

this tread having, viewed in section in a plane containing the thickness of the tread, at least one face delimiting at least one cut covered at least in part with a layer of a covering material, this tread being characterized in that the covering material is a thermoplastic material with a Young's modulus higher than 500 MPa.

The presence of a covering material made of thermoplastic polymer on the edge corners of a tire tread makes it possible to create an effect whereby the blocks of tread pattern bite into a snowy ground thus improving the grip of such a tread on such ground. This is because the layer of covering material has a very high rigidity which allows it to “cut into and scrape” the snow.

### BRIEF DESCRIPTION OF DRAWINGS

The invention and its advantages will be readily understood in the light of the following description and embodiments and from FIGS. 1 to 6 which relate to these embodiments and respectively schematically depict:

FIG. 1 depicts a partial plan view of a block tread pattern of a tread;

FIG. 2 shows the blocks of FIG. 1 in cross section on the line of section II-II;

FIG. 3 shows a plan view of a test specimen for a friction test on snowy ground

FIG. 4 shows the test specimen of FIG. 3 in side view;

FIG. 5 depicts a moulding element according to a method for moulding a tread of the invention;

FIG. 6a illustrates a first moulding step performed by the moulding element of FIG. 5, in which step cutting means are in contact at their end with the covering layer that covers the green form of the tread;

FIG. 6b illustrates a second moulding step in which the blade is in contact with the covering layer that covers the green tire;

FIG. 6c illustrates a third moulding step in which the cutting means and the blade are completely positioned in the green tire; and

FIG. 6d schematically depicts part of the tread according to an embodiment of the invention at the end of the moulding steps of FIGS. 6a-6c.

### I—DETAILED DESCRIPTION OF SPECIFIC EMBODIMENTS

I.1—Definitions

Unless expressly indicated otherwise, all percentages (%) indicated are wt %.

Moreover, any range of values denoted by the expression “between a and b” represents the range of values extending from more than a to less than b (i.e. excluding the end points a and b), whereas any range of values denoted by the expression “from a to b” means the range of values extending from a up to b (i.e. including the strict end points a and b).

“Tire” or “pneumatic tire” means all types of elastic tire whether or not subjected to an internal pressure.

The “tread” of a tire means a quantity of rubbery material delimited by lateral surfaces and by two main surfaces one of which is intended to come into contact with a road surface when the tire is being driven on.

A “tread surface” means the surface formed by those points on the tire tread which come into contact with the road surface when the tire is being driven on.

A “tread pattern element” means elements of the tread which are delimited by cuts, i.e. grooves and/or sipes. Among tread pattern elements a distinction is made between ribs, which go all around the tire, and blocks which do not go all around the tire.

A “mould” means a collection of separate moulding elements which, when brought closer together, delimit a toroidal moulding space.

A “moulding surface” of a mould means the surface of the mould that is intended to mould the tread surface of the tire.

A “blade” of a moulding element means a protrusion projecting from the moulding surface. Among blades, a distinction is made between sipe blades which have a width of less than 2 mm and bars which have a width greater than or equal to 2 mm. The sipe blades are intended to mould sipes in the tread of the tire, i.e. cuts which close up in the contact patch in which the tire is in contact with the ground. The bars are intended to mould grooves in the tread, i.e. cuts which do not close up in the contact patch in which the tire is in contact with the ground.

A “moulding step” means an operation which begins at the moment the blade comes into contact with the material covering the green tire. This operation ends the moment this blade leaves the cut that it has moulded.

I.2—Description of the Tire Tread and of the Tire Covering Material

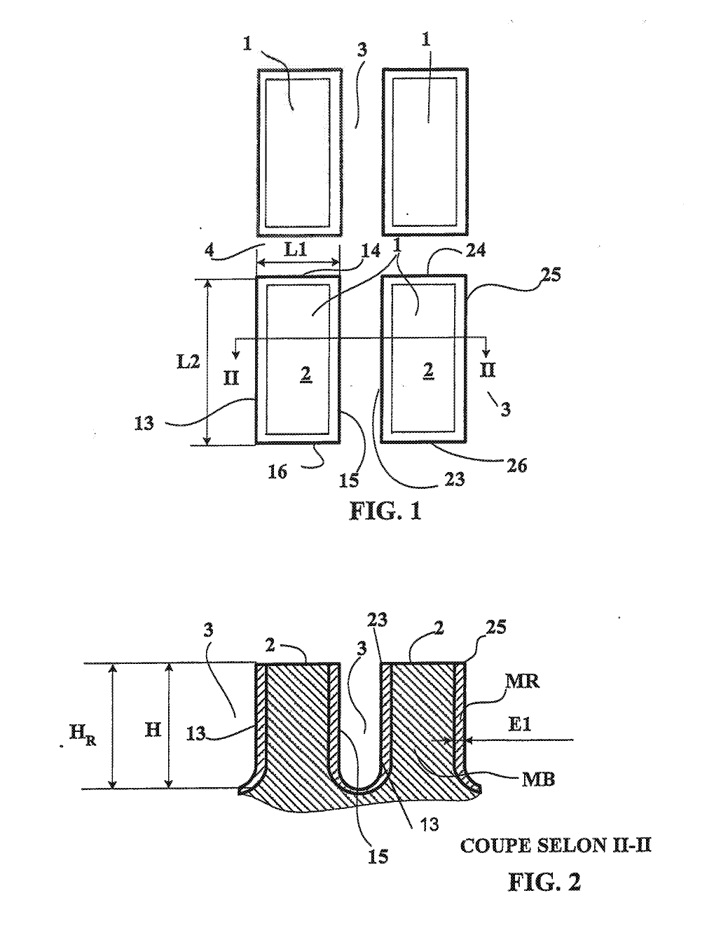

FIG. 1 shows the contact faces 2 of blocks 1 of rectangular shape of a tread pattern according to the invention, said blocks 1 being delimited by grooves 3 running longitudinally and grooves 4 running transversely. Each of these blocks 1 comprises four lateral faces 13, 14, 15, 16 of which the intersections with the contact face 2 respectively form edge corners 23, 24, 25, 26 which play an important part when driving, particularly on road surfaces that have become slippery (notably through the presence of water or snow). Each block 1 is of rectangular shape of width L1 and length L2 (the direction of the length L2 of the blocks being in the case described coincident with the longitudinal direction of the tread or even the circumferential direction of the tire provided with the said tread.

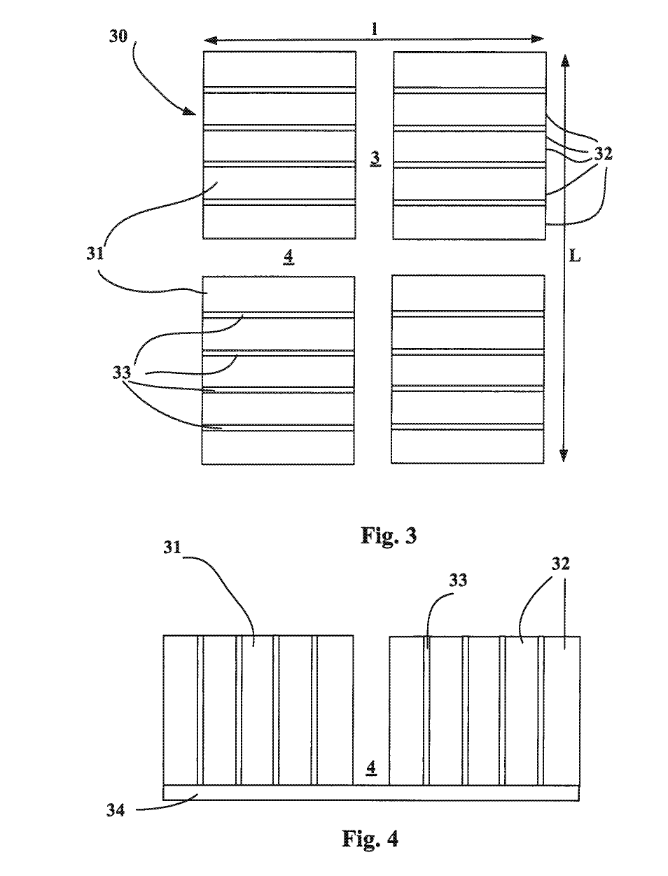

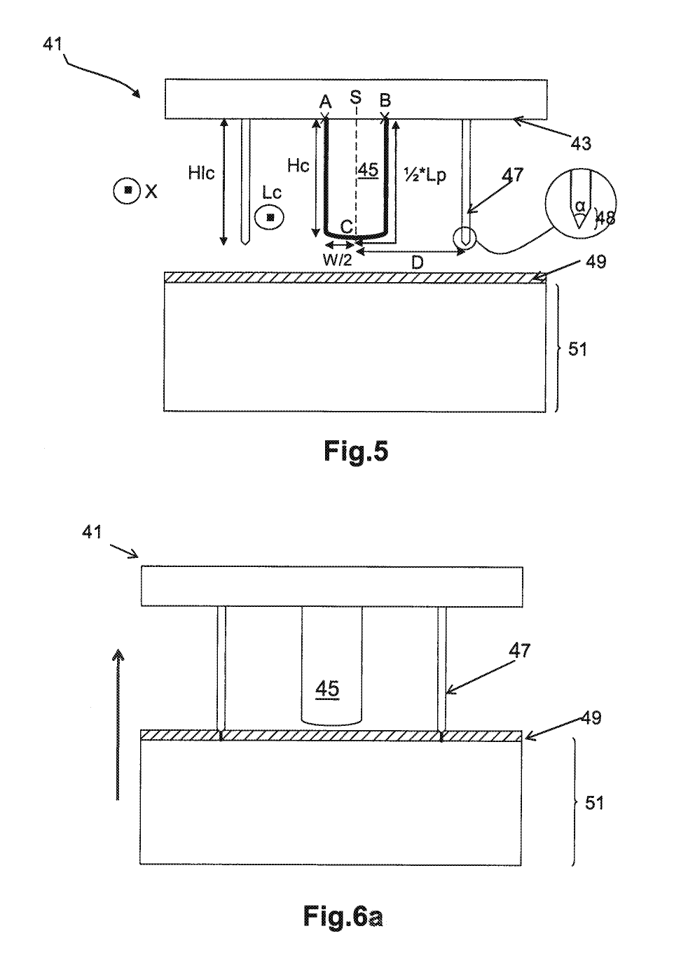

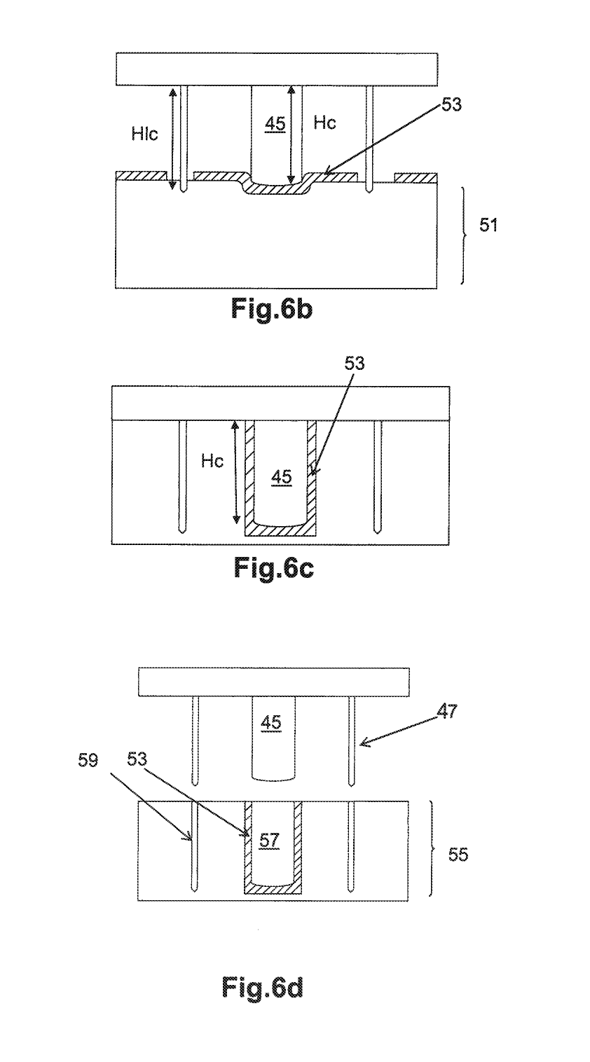

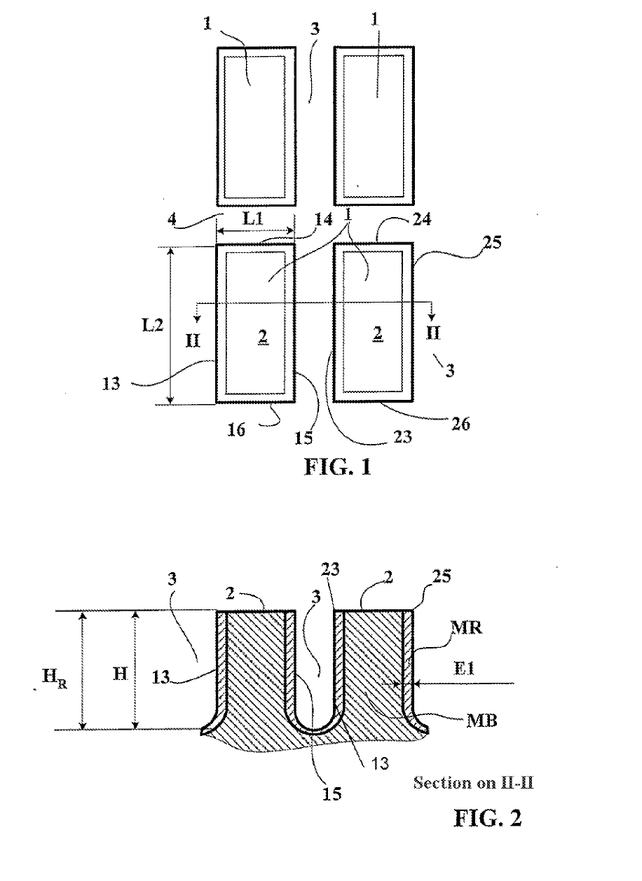

The four lateral faces 13, 14, 15, 16 are completely covered with a substantially constant (over the entire covering height Hr, which in this instance is equal to the depth H of the grooves) thickness E1 (visible in FIG. 2) of a covering material MR different from a rubber composition MB (referred to hereinafter as the base composition) in that the covering material MR is a thermoplastic material.

In the cross section depicted in FIG. 2 and taken on the line II-II of FIG. 1 and perpendicular to the contact faces 2 of two blocks 1, it is possible to see the presence at the surface of the covering material MR on the lateral faces 13 and 15 that bound the longitudinally-running grooves 3.

According to this embodiment of the invention the covering material extends, in the new condition, as far as the edge corner formed by the boundary between the contact face and the lateral face of the said tread pattern element. In this embodiment, the properties of the covering layer are used right from the first few kilometres travelled.

The thickness E1 of the covering material is preferably greater than 0.1 mm, more preferably comprised between 0.25 and 1.0 mm.

According to another embodiment (not depicted) of the invention, the covering material extends radially, in the new condition, from the bottom of the cut, over a height Hr at least equal to 4 mm. That makes it possible, when the residual height of the tread pattern elements is close to 4 mm, to improve the behaviour on snowy ground as the highly rigid covering layer comes into action. Indeed it is known that tires that specialize in having good grip on snowy ground exhibit a drop-off in their performance as the residual thickness of the tread pattern elements reaches around 4 mm and below. For such tires, this embodiment prolongs their intrinsic qualities even with a small height of tread pattern elements.

I.3—Test Methods

I.3.a—Coefficient of Friction Measured on Test Specimens

The friction tests were carried out with a linear tribometer according to the method described in the article entitled “Investigation of rubber friction on snow for tires” written by Sam Ella, Pierre-Yves Formagne, Vasileios Koutsos and Jane R. Blackford (38th LEEDS-Lyons Symposium on tribology, Lyons, 6-9 Sep. 2011).

The parameters of the test are a speed of 0.5 ms⁻¹ and a load of 0.82 kN. The stabilized speed is reached with an acceleration of 5 ms⁻².

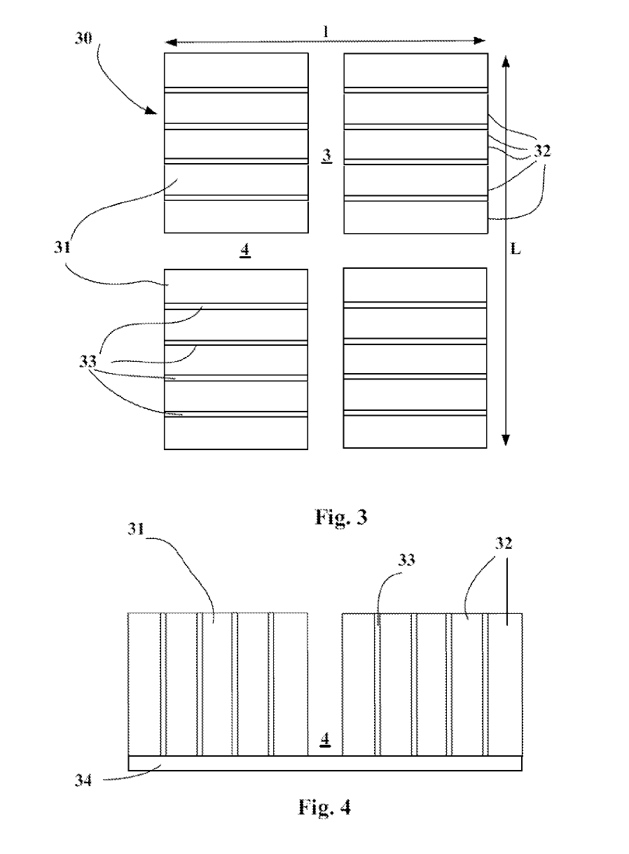

The test specimen 30 used is shown in the appended FIGS. 3 (view from above) and 4 (view from the side). This test specimen is made up of four blocks 31 of rubber compound moulded on a parallelepipedal rubber support 34 (of length L=60 mm, width l=56 mm and thickness 2 mm).

The blocks of width L₁ equal to 25 mm and of length L₂ equal to 27 mm are separated by a longitudinal groove 3 and a transverse groove groove 4, both of the order of 6 mm wide. Each block comprises four sipes 33 of axial orientation Y open on each side of the block and 0.6 mm thick, each dividing the block 31 into five equal parts. The height of the blocks is 9 mm. The test specimen is moved in the longitudinal direction X, normal to the axial orientation Y of the sipes 33.

Each block has a layer of covering material on just one of its edge corners. This edge corner is directed axially.

Tests were carried out on a track of length 110 mm covered with compact artificial snow at a temperature of −10° C.

The load and the tangential force are recorded as the portion of tread moves horizontally. The coefficient of friction is then calculated, this being obtained by dividing the mean value of tangential force by the load applied to the first 30 millimetres of the travel.

I.3.b—Measuring the Coefficient of Friction of a Tire Tread

The tests on tires were carried out in accordance with the method described in document ASTM F1805-00.

I.4—The Covering Material

According to an essential aspect of the invention the tread comprises a covering material which is a thermoplastic material.

This thermoplastic material is a thermoplastic polymer or a composition containing predominantly at least one thermoplastic polymer.

Such material allows the layer of covering material to “cut into and scrape” the snow.

According to one subject of the invention, the covering material is a thermoplastic material which has a Young's modulus higher than 500 MPa.

In the case of the use of a conventional thermoplastic polymer, an adhesive layer is advantageously applied to the said thermoplastic polymer so that it can adhere to the adjacent rubber compositions in the tread of the tire.

According to one particular embodiment of the invention, the thermoplastic polymer is preferably an amorphous polymer. Thermoplastic polymers are characterized by their glass transition temperature (Tg for short); they do not have a melting point: they soften (Tᵣ is the softening temperature) beyond a certain temperature.

According to another embodiment of the invention, the thermoplastic polymer is preferably a semicrystalline polymer. Semicrystalline thermoplastic polymers have a morphology in which amorphous phases and crystalline phases coexist in varying proportions. They have a melting point for the crystalline zones, T_{f}. Beyond that temperature, their structure becomes amorphous.

According to one embodiment, the thermoplastic polymers are shaped in the molten state, i.e. above the melting point of the semicrystalline and above the glass transition temperature for the amorphous.

The melting point or softening temperature of the thermoplastic polymer composition used is preferably chosen higher than 150° C., more preferably higher than 160° C., particularly higher than 200° C., in order to maintain good mechanical integrity while the tire is being cured.

The thermoplastic polymer is preferably selected from the group consisting of polyamides, polyesters, polyimides, cellulose materials, more particularly from the group consisting of polyamides and polyesters. Among the polyamides, mention may notably be made of polyamides 4-6, 6-6, 11 or 12. Among polyesters, mention may be made, for example, of PET (polyethylene terephthalate), PEN (polyethylene naphthalate), PBT (polybutylene terephthalate), PBN (polybutylene naphthalate), PPT (polypropylene terephthalate), PPN (polypropylene naphthalate). Among cellulose materials, mention may notably be made of cellulose acetate.

For certain specific applications for which the curing temperatures may be very low, it is also possible to envisage the use of polyolefins of the polyethylene or polypropylene type.

The thermoplastic polymer is preferably a polyester, more preferably a PET. The thermoplastic polymer is preferably a polyamide, more preferably a polyamide 6 or a polyamide 6-6, more preferably still, a polyamide 6.

According to another subject of the invention, the covering material is a thermoplastic polymer composition with a Young's modulus higher than 100 MPa, and which contains at least one thermoplastic polymer the glass transition temperature of which is positive, a poly(p-phenylene ether) (“PPE”), and a functionalized unsaturated thermoplastic styrene (“TPS”) elastomer the glass transition temperature of which is negative, the said TPS elastomer bearing functional groups selected from the epoxide, carboxy, anhydride or acid ester groups.

The thermoplastic polymer composition has a Young's modulus or elastic modulus in extension at low deformation that is higher than 100 MPa at 23° C., i.e. that is of the order of 10 times higher than the Young's modulus of a rubber composition made of elastomers.

This special composition means that the covering material of the invention can be made to adhere well and directly to a diene elastomer composition or matrix such as those commonly used in pneumatic tires, particularly at high temperature.

The predominant thermoplastic polymer is either amorphous, in which case the melting point (denoted TO of this thermoplastic polymer is preferably higher than 100° C., more preferably higher than 150° C., notably higher than 200° C.

The second essential constituent of the thermoplastic polymer composition according to this embodiment is a functionalized unsaturated thermoplastic styrene elastomer, said elastomer bearing epoxide, carboxy, acid anhydride or acid ester functions or groups.

For preference, the functional groups are epoxide groups, i.e. the thermoplastic elastomer is an epoxy modified elastomer.

The Tg of the said elastomer is, by definition, negative, preferably below −20° C., more preferably below −30° C.

It will be recalled here that TPS (thermoplastic styrene) elastomers are thermoplastic elastomers in the form of styrene-based block copolymers. These thermoplastic elastomers, having an intermediate structure between thermoplastic polymers and elastomers, are made up, as is known, from polystyrene hard sequences linked by elastomer soft sequences, for example polybutadiene, polyisoprene or poly(ethylene/butylene) sequences.

This is why, as is known, TPS copolymers are generally characterized by the presence of two glass transition peaks, the first (lowest, negative temperature, corresponding to Tg₂) peak relating to the elastomer sequence of the TPS copolymer and the second (highest, positive temperature, typically at around 80° C. or more) peak relating to the thermoplastic part (styrene blocks) of the TPS copolymer.

These TPS elastomers are often triblock elastomers with two hard segments linked by a soft segment. The rigid and flexible segments can be positioned linearly, or in a star or branched configuration. These TPS elastomers may also be diblock elastomers with a single hard segment linked to a soft segment. Typically, each of these segments or blocks contains at minimum more than 5, generally more than 10, base units (for example styrene units and isoprene units in the case of a styrene/isoprene/styrene block copolymer). Of course, in that respect they must not be confused with statistical diene copolymer elastomers such as, for example, SIR rubbers (styrene-isoprene copolymers) or SBR rubbers (styrene-butadiene copolymers) which, as is well known, do not have any thermoplastic character.

That reminder having been given, one essential feature of the TPS elastomer used in the covering material of the invention is that it is unsaturated. The expression “unsaturated TPS elastomer” is understood by definition, and as is well known, to mean a TPS elastomer that contains ethylenically unsaturated groups, i.e. it contains carbon-carbon double bonds (whether conjugated or not). Conversely, a saturated TPS elastomer is of course a TPS elastomer that contains no such double bonds.

A second essential feature of the TPS elastomer used in the thermoplastic polymer composition of the invention is that it is functionalized, bearing functional groups selected from the group consisting of epoxide, carboxy, acid ester or anhydride groups or functions. According to one particularly preferred embodiment, this TPS elastomer is an epoxy-modified elastomer, i.e. one that bears one or more epoxy groups.

Preferably, the unsaturated elastomer is a copolymer comprising, as base units, styrene (i.e. polystyrene) blocks and diene (i.e. polydiene) blocks, especially isoprene (polyisoprene) or butadiene (polybutadiene) blocks. Such an elastomer is selected in particular from the group consisting of styrene/butadiene (SB), styrene/isoprene (SI), styrene/butadiene/butylene (SBB), styrene/butadiene/isoprene (SBI), styrene/butadiene/styrene (SBS), styrene/butadiene/butylene/styrene (SBBS), styrene/isoprene/styrene (SIS), styrene/butadiene/isoprene/styrene (SBIS) block copolymers and blends of these copolymers.

More preferably, this unsaturated elastomer is a copolymer of the triblock type, selected from the group consisting of styrene/butadiene/styrene (SBS), styrene/butadiene/butylene/styrene (SBBS), styrene/isoprene/styrene (SIS), styrene/butadiene/isoprene/styrene (SBIS) block copolymers and blends of these copolymers; more particularly, it is an SBS or SIS, especially an SBS.

According to another preferred embodiment of the invention, the styrene content in the unsaturated TPS elastomer is between 5% and 50%. Outside of the indicated range there is a risk that the intended technical effect, namely an adhesion compromise, which is no longer optimal with respect firstly to the covering material made of thermoplastic polymer composition and secondly to the diene elastomer for which the covering material is intended. For these reasons, the styrene content is more preferably between 10% and 40%.

The number-average molecular weight (denoted by Mn) of the TPS elastomer is preferably between 5000 and 500 000 g/mol, more preferably between 7000 and 450 000.

Unsaturated and epoxy modified TPS elastomers, such as SBS for example, are known and commercially available, for example from the company Daicel under the trade name “Epofriend”.

Another feature of the thermoplastic polymer composition is that it comprises, in combination with the thermoplastic polymer and the functionalized unsaturated TPS elastomer, all of which have already been described, at least one poly(p-phenylene ether) (or poly(1,4-phenylene ether)) polymer (known as “PPE” for short).

PPE thermoplastic polymers are well known to a person skilled in the art, they are resins that are solid at ambient temperature (20° C.). For preference, the PPE used here has a glass transition temperature (hereinafter denoted Tg₃) which is higher than 150° C., more preferably higher than 180° C. As for its number-average molecular weight (Mn), this is preferably comprised between 5000 and 100 000 g/mol.

As non-limiting examples of PPE polymers that can be used in the composite reinforcer of the invention, mention may especially be made of those selected from the group consisting of poly(2,6-dimethyl-1,4-phenylene ether), poly(2,6-dimethyl-co-2,3,6-trimethyl-1,4-phenylene ether), poly-(2,3,6-trimethyl-1,4-phenylene ether), poly(2,6-diethyl-1,4-phenylene ether), poly(2-methyl-6-ethyl-1,4-phenylene ether), poly(2-methyl-6-propyl-1,4-phenylene ether), poly-(2,6-dipropyl-1,4-phenylene ether), poly(2-ethyl-6-propyl-1,4-phenylene ether), poly(2,6-dilauryl-1,4-phenylene ether), poly(2,6-diphenyl-1,4-phenylene ether), poly(2,6-dimethoxy-1,4-phenylene ether), poly(1,6-diethoxy-1,4-phenylene ether), poly(2-methoxy-6-ethoxy-1,4-phenylene ether), poly(2-ethyl-6-stearyloxy-1,4-phenylene ether), poly(2,6-dichloro-1,4-phenylene ether), poly(2-methyl-6-phenyl-1,4-phenylene ether), poly(2-ethoxy-1,4-phenylene ether), poly(2-chloro-1,4-phenylene ether), poly(2,6-dibromo-1,4-phenylene ether), poly(3-bromo-2,6-dimethyl-1,4-phenylene ether), their respective copolymers and blends of these homopolymers or copolymers.

According to one particular and preferred embodiment, the PPE used is poly(2,6-dimethyl-1,4-phenylene ether) also sometimes known as polyphenylene oxide (or PPO for short). Such commercially available PPE or PPO polymers are for example the PPEs called “Xyron S202” from the company Asahi Kasei or the PPEs called “Noryl SA120” from the company Sabic.

For preference, in the thermoplastic polymer composition of the composite reinforcement of the invention, the amount of PPE polymer is adjusted so that the weight content of PPE is comprised between 0.05 and 5 times, more preferably between 0.1 and 2 times the content by weight of styrene present in the functionalized TPS elastomer itself. Below the recommended minimum values, the adhesion of the covering material to the rubber may be reduced whereas above the indicated maximum values, there is a risk of the layer being weak.

For all these reasons, the weight content of PPE is more preferably still between 0.2 and 1.5 times the weight content of styrene in the TPS elastomer.

The Tg of the above thermoplastic polymers (Tg₁, Tg₂ and Tg₃) is measured, in a known manner, by DSC (Differential Scanning Calorimetry), for example and unless specifically indicated otherwise in the present application, according to the ASTM D3418 standard of 1999.

The number-average molecular weight (Mn) is determined, in a known manner, by size exclusion chromatography (SEC). The sample is firstly dissolved in tetrahydrofuran at a concentration of about 1 g/l and then the solution is filtered through a filter with a porosity of 0.45 μm before injection. The apparatus used is a WATERS Alliance chromatograph. The elution solvent is tetrahydrofuran, the flow rate is 0.7 ml/min, the temperature of the system is 35° C. and the analytical time is 90 min. A set of four WATERS columns in series, with the “Styragel” trade names (“HMW7”, “HMW6E” and two “HT6E”), is used. The injected volume of the solution of the polymer sample is 100 μl. The detector is a WATERS 2410 differential refractometer and its associated software, for handling the chromatograph data, is the WATERS MILLENIUM system. The calculated average molar masses are relative to a calibration curve produced with polystyrene standards.

Although the three constituent ingredients described hereinabove (the thermoplastic polymer, the functionalized unsaturated TPS elastomer and the PPE) are sufficient on their own to give the covering material of the invention very good properties of adhesion to an unsaturated rubber such as natural rubber, certain conventional additives such as colorant, filler, plasticizer, tackifier, antioxidant or other stabilizer, crosslinking or vulcanizing system such as sulphur and accelerator, may potentially be added to the thermoplastic polymer composition described hereinabove.

According to another embodiment of the invention, the covering material is made up of at least two layers, one being a thermoplastic material with a Young's modulus higher than 500 MPa, the other being a thermoplastic polymer composition with a Young's modulus higher than 100 MPa containing at least one thermoplastic polymer the glass transition temperature of which is positive, a poly(p-phenylene ether) (“PPE”), and a functionalized unsaturated thermoplastic styrene (“TPS”) elastomer the glass transition temperature of which is negative, the said TPS elastomer bearing functional groups selected from the groups consisting of epoxide, carboxy, anhydride or acid ester groups.

The covering material made of thermoplastic polymer composition may comprise additives added to the polymer, notably at the time of forming the latter, it being possible for these additives to be, for example, agents that protect against ageing, plasticizers, fillers such as silica, clays, talc, kaolin or even short fibres; fillers may for example be used to make the surface of the film rough and thus contribute to improving its keying to the glue and/or its adhesion to the layers with which it is intended to be in contact.

I.5—Adhesion of the Covering Material to the Rubber Compositions of the Tire Tread

In instances in which the covering material is a thermoplastic polymer, this material is preferably provided with a layer of adhesive facing each layer of rubber composition of the tire with which it is in contact.

According to one particular embodiment of the invention, in order to make the rubber adhere to the thermoplastic polymer use may be made of any appropriate adhesive system, for example a simple textile glue of the “RFL” (resorcinol-formaldehyde-latex) type containing at least one diene elastomer such as natural rubber, or any equivalent glue known to confer satisfactory adhesion between conventional rubber and a conventional thermoplastic film, such as films of polyester or polyamide.

By way of example, the glue application process may essentially comprise the following successive steps: passage through a bath of glue, followed by an excess-removal operation (for example using blowing, sizing) to eliminate the excess glue; then drying for example by passage through an oven (for example for 30 s at 180° C.) and finally heat treatment (for example for 30 s at 230° C.°).

Prior to the glue application process above, it may be advantageous to activate the surface of the film, for example using a mechanical and/or physical and/or chemical means, in order to improve the keying of the glue and/or its final adhesion to the rubber. A mechanical treatment may for example consist in a prior step of peeling or grooving the surface; a physical treatment may for example consist of a treatment using irradiation such as a beam of electrons; a chemical treatment may for example consist in a prior passage through a bath of epoxy resin and/or isocyanate compound.

As the surface of the thermoplastic material is, as a general rule, particularly smooth, it may also be advantageous to add a thickener to the glue used, so as to improve the overall keying of the glue to the film during the glue application process.

I.6—Methods of Manufacturing a Tread Comprising a Covering Layer

One means of obtaining such a tread pattern is for example to cover a green form of tread made from a base compound with a layer of covering compound of suitable thickness before the tread and the grooves and the sipes are moulded. After moulding, the covering compound which is at the contact face of the rib can be left in place or alternatively eliminated via mechanical means (notably by grinding).

Another way of producing a tread according to the invention industrially may consist in applying, to the unvulcanized green form of the tire provided with a tread made of unvulcanized base compound, thin strips of a compound different from the base compound, as described in document EP 0510550 (it being possible for the thin strips to be applied to the tread in the circumferential and/or transverse direction). Another way may consist in producing the tread by coextruding two (or more) compounds when the tread is being extruded.

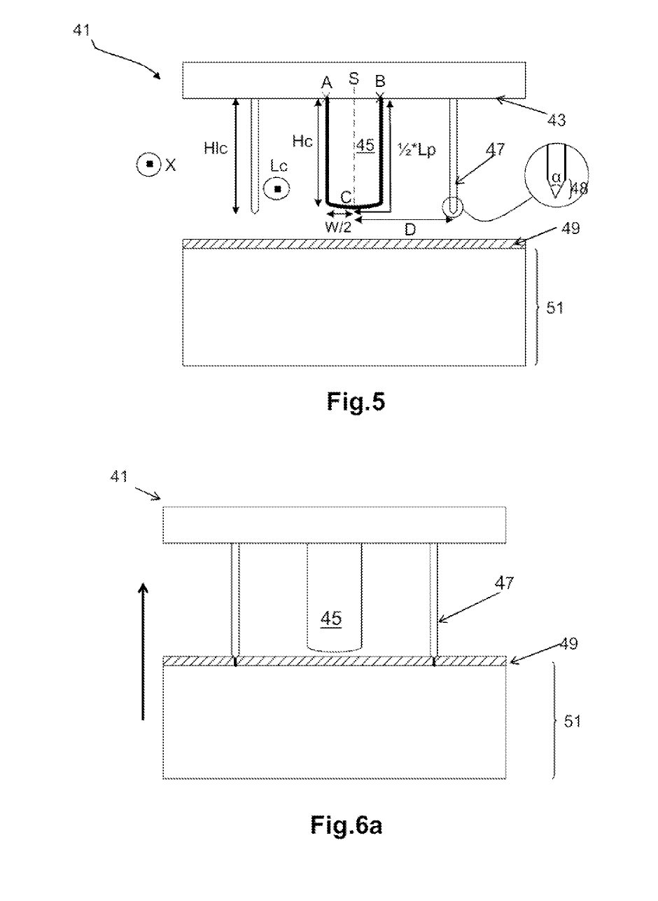

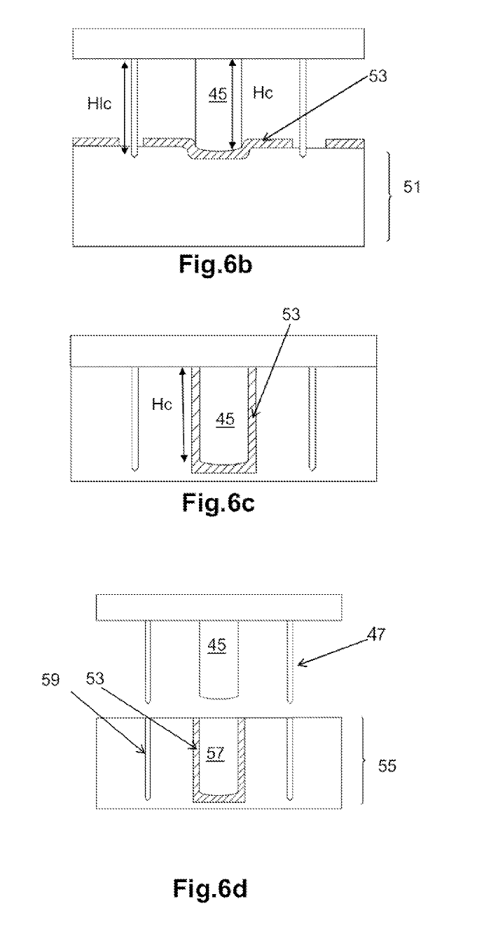

Another embodiment of the invention preferably consists of a moulding element of a mould for moulding and vulcanizing a tread of a tire, the tread of which comprises a tread surface intended to come into contact with the ground when the said tire is being driven on, this moulding element comprising a moulding surface intended to mould part of the tread surface of the tire and a blade of length Lc and of height Hc intended to mould a sipe or a groove in the tread, this blade comprising for example a rounded end extending in the length of the blade in a particular direction of extension. The moulding element comprises two cutting means arranged one on either side of the blade a certain distance from this blade and each cutting means comprises a cutting edge extending in the direction of extension, this cutting edge making an acute angle α in a cutting plane perpendicular to this direction of extension. This embodiment is explained using the description of FIGS. 5 and 6 which follows, in which elements which are substantially identical or similar will be denoted by identical references.

FIG. 5 depicts a moulding element 41 according to one aspect of the invention.

More particularly, the moulding element 41 comprises a moulding surface 43 intended to mould part of the tread surface of a tire. The moulding element 41 also comprises blades 45 just one of which has been depicted here to make the invention easier to understand. The blade in this instance is a bar 45 intended to mould a groove in the tread of the tire. What is meant by a “groove” in a tread is a cut into this tread of which the width, i.e. the distance separating two lateral walls of this groove, is greater than 2 mm. The bar 45 also extends heightwise from this moulding surface 43. The bar 45 also extends lengthwise in a direction of longitudinal extension X while projecting from the moulding surface 43. In the mould, this direction may be a circumferential direction which follows the circumference of the mould. As an alternative, the direction of longitudinal extension is a transverse direction perpendicular to the circumferential direction of the mould. In another alternative form, this direction of longitudinal extension is an oblique direction making a non-zero angle with the circumferential direction and the transverse direction of the mould.

FIG. 5 depicts the moulding element 41 viewed in a plane of section perpendicular to the direction of extension X. In this plane of section, the bar 45 has a cross section exhibiting symmetry about an axis of symmetry S. The axis of symmetry S here extends in the height Hc of the bar 45 and divides this bar 45 into two half-bars of width W/2.

The cross section of the bar in this instance is of rectangular shape. “Rectangular shape” means that the upper face of the bar is perpendicular to the lateral faces of this bar, i.e. that the lateral faces of the bar make with the upper face of this bar an angle comprised between 85° and 95°.

The invention also encompasses instances in which the regions of connection between the lateral faces of the bar and the upper face of this bar are rounded and instances in which the regions of connection between the lateral faces of the bar and the base are likewise rounded.

In additional alternative forms of embodiment, the cross section of the bar may adopt a shape other than a rectangular shape, such as a square shape, a triangular shape, etc.

It will also be noted that the cross section of the bar 45 has, between two points of intersection A and B of the bar 45 with the moulding surface 43, a profile that has been indicated in bold lines in FIG. 5. This profile has a profile length Lp such that Lp=2*(Hc+W/2), i.e. the profile length Lp corresponds to twice the height Hc of the bar 45 plus the width W of this bar.

In the example of FIG. 5, the points of intersection A and B are easy to determine, the lateral walls of the bar 45 being perpendicular to the mould surface 43. As an alternative, in instances in which the lateral walls of the bar are connected to the moulding surface 43 by two rounded regions of connection forming two arcs of a circle, the points of intersection A and B correspond respectively to the intersection of the arcs of a circle with straight lines passing through the centres of the arcs of a circle and dividing these arcs into two identical ½ arcs.

The moulding element 41 of FIG. 5 also has two cutting means 47 arranged one on each side of the bar 45. These cutting means extend along their length in a direction parallel to the longitudinal direction X of the bar 45. A “direction parallel” means that the direction in which the cutting means extend makes an angle comprised between −5° and +5° with the direction of longitudinal extension X of the bar. The height Mc of the cutting means is at least equal to the height Hc of the bar.

Each cutting means has an end 48 able to cut a layer 49 of a predetermined material, referred to in the remainder of the description as the covering material, this special material covering a green form 51 of a tire tread. More particularly, each cutting means comprises at its end a cutting edge (depicted as a point in FIG. 5). This cutting edge has, in the plane of FIG. 5, an angle α smaller than or equal to 60° (refer to the inset detail associated with FIG. 5 which is an enlargement of the end of one of the two cutting means 47). In a preferred embodiment, the angle α is smaller than or equal to 35°.

It will be noted that this cutting edge may have been hardened beforehand in order to improve its mechanical integrity over time. For example, the cutting edge may have been hardened during a special heat treatment. As an alternative, it is possible to plan for the material of which the cutting edge is made to be stronger than the rest of the moulding element.

It will also be noted that the cutting means 47 are arranged in the moulding element 41 in such a way that the distance D between each end of the cutting means and the axis of symmetry S of the cross section of the bar 45 is less than or equal to half the length Lp of the profile of the section, such that D=Hc+W/2. Stated differently, the axis of symmetry S intersects the profile of the bar 45 at a point C to define two sub-profiles. A first sub-profile corresponds to the segment A-C and a second sub-profile corresponds to the segment B-C. For each cutting means, the distance between the cutting edge of this cutting means and the axis of symmetry S is less than or equal to the length of the sub-profile adjacent to this cutting means, i.e. the sub-profile belonging to the nearest half-bar of the cutting means. In the example of FIG. 5, the closest sub-profile of the cutting means 47 is the sub-profile corresponding to segment B-C.

FIGS. 6a to 6c illustrate in greater detail the various steps for placing the covering material in a groove of the tread.

FIG. 6a notably discloses a first step in which the moulding element 41 and the green tire 51 are brought closer together. This bringing-together movement is initiated, for example, by a membrane (not depicted) in the mould. Under the action of a quantity of pressurized steam, this membrane inflates and pushes the green tire towards the moulding element 1. More specifically, FIG. 6a shows the moment at which the cutting means 47 cut into the covering material 49. This cutting step is made easier by the action of the cutting edges of the cutting means.

FIG. 6b illustrates a second step in which the bar 45 is pushed into the green tire 51. More particularly, in this step, the bar 45 comes into contact with a bit 53 of material that has been cut in the layer of covering material. The bar 45 thus drives this bit 53 into the depth of the green tire 51.

It will be noted here that the height Hlc of the cutting means 47 is greater than the height Hc of the bar 45. Thus, the cutting step of FIG. 6a comes before the step in which the bar 45 pushes into the green tire 51. As an alternative, it is possible to plan for the height Hlc of the cutting means 47 to be identical to the height Hc of the bar 45. In that case, the step of FIG. 6a and the step of FIG. 6b occur simultaneously.

FIG. 6c illustrates a third step in which the bar 45 is pushed into the green tire over its entire height Hc. All of the bit 53 of covering material therefore finds itself within the green tire. Once this step has been performed, it is then possible to vulcanize the green tire, i.e. to convert the rubber material of which the green tire is made from the plastic state to the elastic state.

FIG. 6d depicts the result of the various steps of moulding and vulcanizing the green tire illustrated in FIGS. 6a to 6c. The bit of tread 55 thus obtained comprises a groove 57 obtained by a moulding rubber around the bar 45 and two sipes 59 obtained by moulding rubber around the two cutting means 47. It will be noted here that all of the walls of the groove, i.e. the lateral walls and the bottom wall flanked by the lateral walls, are covered by the cut bit 53 of covering material.

### II—EXAMPLES OF THE IMPLEMENTATION OF THE INVENTION

II.1—Preparing the Covering Material

The thermoplastic material comes in the form of granules.

The granules are then worked using an extrusion method followed by a calendering method or by an extrusion method, followed by a blowing method. A person skilled in the art will know how to optimize the parameters of the methods to suit each type of thermoplastic polymer.

In the case of a thermoplastic formulation, this is produced using a corotating twin screw extruder and is then converted into the form of granules as it leaves the die.

II.2—Tests on Tire Tread Test Specimens

The tests which follow demonstrate the excellent friction properties of the test specimens of tire tread pattern on snowy ground.

For the purposes of these tests, four test specimens of blocks of tread pattern for alpine tires were produced, and referred to as PS.1, PS.2, PS.3 and PS.4. Tread pattern block PS.1 has none of the faces delimiting the cuts covered with a thermoplastic material. Tread pattern block PS.2 has one face delimiting each cut covered with a covering material of PET polyester polymer type, precoated with an RFL adhesive, with a thickness of 0.5 mm. Tread pattern blocks PS.3 and PS.4 have one face delimiting a cut covered with a covering material of the type consisting of a composition of thermoplastic polymer based on 70% polyamide-6 (of make “Ultramid B33” by BASF), 21% of epoxy-modified SBS (of the make “Epofrind AT501” by Daicel Chemical Industries), 9% PPE (of make “Xyron S202A” by Asahi Kasei Plastics), and respectively having thicknesses of 0.4 mm and 0.25 mm.

The tests made it possible to measure the coefficients of friction of the 4 test specimens, here expressed in relative terms with respect to the reference test specimen PS.1 where its value has been arbitrarily fixed at 100. The results are set out in the attached Table 1.

It is noted that the tread pattern blocks PS.2 and PS.3, of which one face delimiting each cut is covered with a covering material respectively of polyester polymer type and of a composition based on a polyamide polymer have a coefficient of friction that is higher than that of the tread pattern block PS.1 of which none of the faces delimiting the cuts is covered with a thermoplastic material.

Test specimen PS.4 has a coefficient of friction that is lower than that of PS.3 because the thickness of the edge corner that is covered with a thermoplastic polymer material is smaller than that of the edge corner of test specimen PS.3, testifying to the effect that the thickness of the edge corner has on the value of the coefficient of friction; the thicker the edge corner the greater an effect it has on the friction of the tread on the snowy track.

II.3—Tests Carried Out on Tires

Tests are carried out on two tires. One is equipped with a reference tread P.1 based on a conventional rubber compound, with no covering compound present. The other is equipped with a tire tread P.2 according to the invention, based on the same base compound as the tread of the reference tire with, in addition, a covering material 0 5 mm thick, made of PET and precoated with RFL adhesive.

The tests carried out on the tires are carried out in accordance with the method described in document ASTM F1805-00. The results are listed in Table 2.

The tire equipped with the tread according to the invention has a coefficient of friction on snowy ground that is higher than that of the tread of the reference tire that has no covering material.

TABLE 1

| Tread pattern block test specimen | PS.1 | PS.2 | PS.3 | PS.4 |
|---|---|---|---|---|
| Coefficient of friction | 100 | 115 | 112 | 102 |

TABLE 2

| Tire | P.1 | P.2 |
|---|---|---|
| Coefficient of friction | 100 | 112 |

1. A tire tread comprising:
a plurality of tread pattern elements comprising lateral faces and a contact face which is adapted to be in contact with the road surface when a tire provided with this tread is being driven on, the extent of the contact between the contact face and the ground forming at least one edge corner,
a plurality of cuts in the form of grooves and/or sipes, said cuts being delimited by opposing lateral faces,
wherein each tread pattern element is formed with at least one first rubber compound (referred to as “base compound”),
wherein the tread has, viewed in section in a plane containing the thickness of the tread, at least one face delimiting at least one cut covered at least in part with a layer of a covering material, wherein the covering material is a thermoplastic material with a Young's modulus higher than 500 MPa.

2. The tread according to claim 1, wherein the thermoplastic material is a thermoplastic polymer or a composition containing predominantly at least one thermoplastic polymer.

3. A tire tread comprising:
a plurality of tread pattern elements comprising lateral faces and a contact face which is intended to be in contact with the road surface when a tire provided with this tread is being driven on, the extent of the contact between the contact face and the ground forming at least one edge corner,
a plurality of cuts in the form of grooves and/or sipes, said cuts being delimited by opposing lateral faces,
wherein each tread pattern element is formed with at least one first rubber compound (referred to as “base compound”),
wherein the tread has, viewed in section in a plane containing the thickness of the tread, at least one face delimiting at least one cut covered at least in part with a layer of a covering material, wherein the covering material is a thermoplastic polymer composition with a Young's modulus higher than 100 MPa, and wherein the thermoplastic polymer composition contains at least one thermoplastic polymer the glass transition temperature of which is positive, a poly(p-phenylene ether) (“PPE”), and a functionalized unsaturated thermoplastic styrene (“TPS”) elastomer the glass transition temperature of which is negative, the TPS elastomer bearing functional groups selected from the epoxide, carboxy, anhydride or acid ester groups.

4. The tread according to claim 1, wherein the covering material comprises at least two layers, wherein one layer is a thermoplastic material with a Young's modulus higher than 500 MPa, and the other layer is a thermoplastic polymer composition with a Young's modulus higher than 100 MPa containing at least one thermoplastic polymer the glass transition temperature of which is positive, a poly(p-phenylene ether) (“PPE”), and a functionalized unsaturated thermoplastic styrene (“TPS”) elastomer the glass transition temperature of which is negative, the TPS elastomer bearing functional groups selected from the groups consisting of epoxide, carboxy, anhydride and acid ester groups.

5. The tread according to claim 1, wherein the covering material extends, from the bottom of the at least one cut, over a height Hr at least equal to 4 mm of the height H of the lateral face.

6. The tread according to claim 1, wherein the covering material extends, in the new condition, as far as the edge corner formed by the boundary between the contact face and the lateral face of said tread pattern element.

7. The tread according to claim 2, wherein the thermoplastic polymer is an amorphous thermoplastic polymer.

8. The tread according to claim 2, wherein the thermoplastic polymer is a semicrystalline thermoplastic polymer.

9. The tread according to claim 2, wherein the thermoplastic polymer is selected from the group consisting of polyesters, polyamides, aromatic polyamides, polyimides, cellulose materials and mixtures thereof.

10. The tread according to claim 9, wherein the thermoplastic polymer is a polyester selected from the group consisting of PET (polyethylene terephthalate), PEN (polyethylene naphthalate), PBT (polybutylene terephthalate), PBN (polybutylene naphthalate), PPT (polypropylene terephthalate), PPN (polypropylene naphthalate).

11. The tread according to claim 9, wherein the thermoplastic polymer is a polyamide selected from the group consisting of polyamide 4-6, 6-6, 6, 11 or 12.

12. The tread according to claim 9, wherein the thermoplastic polymer is cellulose acetate.

13. The tread according to claim 2, wherein the thermoplastic polymer composition contains at least one thermoplastic polymer the glass transition temperature of which is positive, a poly(p-phenylene ether) (“PPE”), and a functionalized unsaturated thermoplastic styrene (“TPS”) elastomer the glass transition temperature of which is negative, the said TPS elastomer bearing functional groups selected from the epoxide, carboxy, anhydride and acid ester groups.

14. The tread according to claim 1, wherein the thermoplastic material has a melting point or a softening temperature higher than 150° C.

15. The tread according to claim 1, wherein the covering material has a thickness greater than 0.1 mm.

16. The tread according to claim 15, wherein the covering material has a thickness comprised between 0.25 and 1.0 mm.

17. The tread according to claim 1, wherein the layer of the covering material is provided with a layer of adhesive facing each adjacent layer of rubber composition.
